(19) United States
(12) Patent Application Publication
(10) Pub. No.: US 2007/0189298 A1
(43) Pub. Date: Aug. 16, 2007

(54) Distributed wireless network with dynamic bandwidth allocation

(75) Inventors: Witty Wong, Tai Po (CN); Zu Yuan Fang, Shatin (CN); Quan Long Ding, ApLeiChau (CN); Peter Diu, Kowloon (CN)

Correspondence Address: BUCHANAN, INGERSOLL & ROONEY PC, POST OFFICE BOX 1404, ALEXANDRIA, VA, 22313-1404, US

(73) Assignee: HONG KONG APPLIED SCIENCE AND TECHNOLOGY RESEARCH INSTITUTE CO., LTD, Pak Shek Kok, New Territories (CN)

(21) Appl. No.: 11/354,012

(22) Filed: Feb. 15, 2006

(51) Int. Cl. H04J 1/16; H04L 12/16; H04L 12/56; H04J 3/22

(52) U.S. Cl. 370/395.1; 370/468; 370/252; 370/260

(57) ABSTRACT

A communication network includes a plurality of communication nodes, each of which can transmit data at a variable bandwidth. Each communication node predicts its own bandwidth requirements, and communicates its predicted own bandwidth requirements to the network. The nodes acquire bandwidth requirement information of other communication nodes on the network, and each one determines its own bandwidth allocation according to a common bandwidth allocation scheme. The common bandwidth allocation scheme is available to the plurality of communication nodes.

### FIELD OF THE INVENTION

This invention relates to a communication network and, more particularly, to a distributed wireless communication network. More specifically, but not exclusively, this invention relates to a distributed wireless network with dynamic bandwidth allocation.

### BACKGROUND OF THE INVENTION

A communication network which has the capability of allocating transmission bandwidth dynamically to a plurality of communication nodes connected to the network to meet the instantaneous traffic requirements of individual nodes is desirable to enhance quality of service (QOS). Dynamic bandwidth allocation is a broad term concerning methodology of allocating data transmission bandwidth in a communication network according to instantaneous requirements. In a data communication network, the total available bandwidth on the network is always limited and each communication node will have to compete for an adequate amount of bandwidth in order to transmit data to fulfil an expected QOS level. For a centralized network, all traffic has to go through a central controller and the allocation of bandwidth to each of the communication nodes connected to the network can be quite easily determined by the central controller. On the other hand, there is no central controller in a de-centralized or a distributed communication network. For such a distributed communication network, an optimal allocation of transmission bandwidth to the individual communication nodes is a difficult task.

A contention-based access method has been proposed for distributed communication network. However, this kind of access methods usually result in a schedule that does not take into account the service requirements or priorities of different traffic and are therefore not desirable, since a reasonable level of quality of service cannot be guaranteed.

In another type of conventional dynamic bandwidth allocation schemes, traffic is categorized and with bandwidth allocated according to a prescribed set of rules of priority. For example, delay sensitive data traffic, such as, for example, video traffic is transmitted with priority over delay insensitive data traffic, such as ordinary data traffic. When data traffic of the same priority is competing for a limited available bandwidth, the resulting bandwidth allocation can be somewhat unpredictable.

Furthermore, conventional dynamic bandwidth allocation schemes typically operate on the assumptions that the requested bandwidth is known. This may not be the case. For example, data traffic may have a time variant traffic pattern. A bandwidth allocation scheme operating on the assumption of a known bandwidth requirement will not be optimal.

### OBJECT OF THE INVENTION

Accordingly, it is an object of the present invention to provide a distributed communication network with enhanced dynamic bandwidth allocation schemes. At a minimum, it is an object of this invention to provide the public with a useful choice of a dynamic bandwidth allocation scheme for use with a distributed communication network.

### SUMMARY OF THE INVENTION

Broadly speaking, the present invention has described a communication network comprising a plurality of communication nodes, wherein each one of said plurality of communication nodes can transmit data at a variable bandwidth, each communication node comprises:
Means for predicting its own bandwidth requirements,
Means for communicating its predicted own bandwidth requirements to the network,
Means for acquiring bandwidth requirement information of other communication nodes on the network, and
Means for determining its own bandwidth allocation according to a common bandwidth allocation scheme, said common bandwidth allocation scheme is available to said plurality of communication nodes.

This dynamic bandwidth allocation facilitates efficient bandwidth utilization in a distributed communication network.

According to another aspect of the present invention, there is provided a method of bandwidth management for a distributed communication network, the distributed communication network comprises a plurality of communication nodes, the method comprises the following steps:
Predicting bandwidth requirements of the plurality of communication nodes,
Communicating bandwidth requirements of said plurality of communication nodes onto said communication network,
Allocating communication bandwidth to said plurality of communication nodes according to a common allocation scheme shared by said plurality of communication nodes.

Preferably, said bandwidth requirements of a communication node are broadcast to said plurality of communication nodes. Each of the plurality of the communication nodes will be able to obtain the same information on bandwidth requirements to facilitate optional bandwidth allocation.

Preferably, network communication uses a time division multiple access protocol, the protocol divides a communication time period in the network into a plurality of time slots, a prescribed number of time slots is reserved for exchange of bandwidth information between the communication nodes and a prescribed number of time slots is reserved for data transmission by the communication nodes.

Preferably, each time channel is a superframe comprising 256 time slots, each time slot is 256 μs long, prescribed time slots in a superframe are reserved for a specific communication node for exchange of bandwidth information and transmission of data upon admission into the network.

Preferably, bandwidth requirements of said plurality of communication nodes are broadcast during beacon period.

Preferably, said common bandwidth allocation scheme comprises a fair share allocation scheme whereby transmission bandwidth allocated to a specific communication node is dependent on its predicted bandwidth requirements relative to the overall bandwidth requirements of said plurality of communication nodes.

Preferably, each one of said plurality of communication nodes comprises means for contending for additional bandwidth when the bandwidth required by a said communication node exceeds the bandwidth reserved by said communication node.

Preferably, said additional bandwidth is contended by a communication node through a set of bandwidth contention protocol common to said plurality of communication nodes.

Preferably, only one communication node is allowed to contend for additional bandwidth during a said time slot during which said plurality of communication nodes can communicate with each other.

Preferably, the prescribed set of bandwidth allocating rules comprises rules of prioritising bandwidth allocation to a communication node.

Preferably, each communication means comprises means for causing data communication in said distributed network at a variable bandwidth.

Preferably, said means for causing data communication in said distributed network can increase as well as decrease the data communication bandwidth of said communication node, the increase and decrease in data communication bandwidth is broadcast in said communication network during the beacon period.

Preferably, said communication node further comprises means to release data communication bandwidth for use by other communication nodes if the predicted bandwidth requirement of said communication node is lower than existing bandwidth requirements.

Preferably, said communication node further comprises means to compete for additional data communication bandwidth for its own use if the predicted bandwidth requirement of said communication node is higher than current bandwidth.

Preferably, said means for predicting bandwidth requirements of a communication node comprises means to predict immediate subsequent bandwidth of incoming traffic from traffic pattern of the most recent incoming traffic.

Preferably, said means for predicting bandwidth requirements of said communication node further comprises means to determine data traffic buffered in said communication node so that the predicted bandwidth requirements is a function of both the traffic pattern of current incoming traffic and the buffered traffic.

### BRIEF DESCRIPTION OF THE DRAWINGS

Preferred embodiments of the present invention will be explained in further detail below by way of examples and with reference to the accompanying drawings, in which:

FIG. 1 is a network layer model of video transmission width according to IEEE 1394 or USB over UWB,

FIG. 2 is a flow chart showing an exemplary dynamic bandwidth allocation scheme of this invention,

FIG. 3 is a flow diagram showing the algorithm for releasing bandwidth by a communication node,

FIG. 4 is a flow chart showing an alternative scheme for releasing bandwidth to the network,

FIG. 5 shows an exemplary distributed network of this invention, and

FIG. 6 is a block diagram showing an exemplary node.

### DETAILED DESCRIPTION OF THE PREFERRED EMBODIMENTS

In the following, a decentralized network operating under the MBOA (Multi-Band OFDM Alliance) protocol will be explained as an implementation example of a communication network employing an exemplary distributed bandwidth allocation (DBA) scheme. However, it should be appreciated that the DBA scheme and devices of this invention is not limited to an MBOA system and can be applied to any ad hoc distributed communication networks, especially a network which support a “beacon” period and contention-based/reservation-based data period.

In order to facilitate understanding of the implementation example, a brief explanation will be given below concerning components of the MAC layer as defined by WiMedia MBOA (“MBOA MAC”).

In a MBOA MAC distributed network, there is no central controller which will define the formation and operation of the network. The communication nodes are connected to the network and share transmission bandwidth through a TDMA (Time Domain Multiple Access) based protocol. Channel time is divided into “superframes”. Each superframe is 65 ms long and consists of 256 timeslots of 256 μs each, which are known as Media Access Slots (“MAS”). Thus, the network is a TDMA system and at any instant, there is only one device transmitting data. At the beginning of each superframe, there is a beacon period. The beacon period is followed by a data transfer period. During the beacon period, each communication device (or communication node) sends out its beacon packet in turn. In a beacon packet, information elements (IEs) will be broadcasted so that the status of a node will be made known to the other nodes. During the data transfer period, nodes can gain access to the channel either through Distributed Reservation Protocol (DRP) or Prioritized Contention Access (PCA). DRP is the means for a device to reserve some timeslots for its communication to another device. If a time slot has been reserved by a device, no other devices can transmit data during that time. For timeslots that have not been reserved by anyone device, any of the devices can contend for access to the channel during that period through PCA.

The IEs sent in the beacon will include, among others, DRP IEs and some Application Specific IEs (ASIEs). A DRP IE contains information on the reservation of timeslots by a device for transmission to another destination node. For example, if another reservation is made for communication to yet another node, two DRP IEs will have to be sent. ASIE is a vendor specific IE which is typically defined by individual vendors for sending information that may be required for specific applications or algorithms. Multiple ASIEs can be defined for different applications. However, it should be noted that because ASIE is vendor specific, an ASIE of devices coming from a vendor may not be understandable by devices of another vendor.

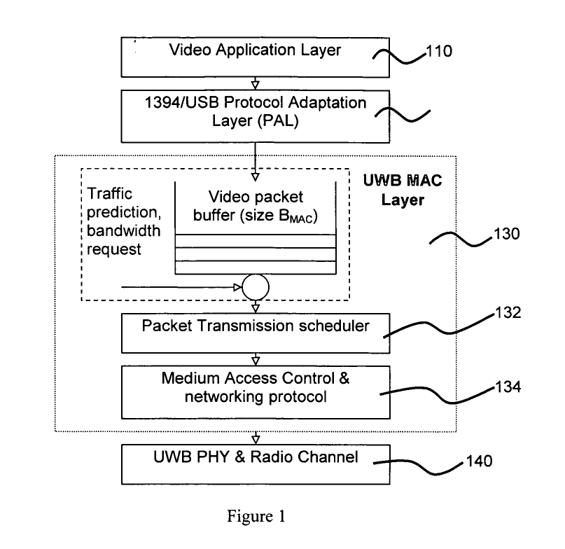

FIG. 1 shows a layered node network model in which an exemplary DBA algorithm is resident. This is a typical structure of a media application node. At the top, there is a video application layer 110 which is for user interaction. The video application layer may comprise any computer program or application utility, and the application protocol can be independent of the lower layer. A protocol adaptation layer (PAL) 120 provides a platform for the different application layer data format to work with a common UWB (ultra-wide band) MAC layer 130. The upper layer protocols may include, but not limited to, USB, 1394, IP, or other appropriate protocols, the appropriate standards are incorporated herein by reference. The DBA scheme, which will utilize the video packet buffer (which stores video packets which have not been sent out) and will incorporate a traffic prediction scheme and bandwidth request mechanism (which will be elaborated in following sections), will be implemented on the MAC layer 134, which will also consist of a packet transmission scheduler and other MAC and networking protocol to carry out coordinated network resources access. The packet transmission scheduler 132 is responsible for controlling and keeping track of the order of transmission of the packets in the buffer. Medium Access Control (MAC) and networking protocol is implemented to ensure access to network resources is coordinated efficiently, and that no two devices would try to access the medium at the same time. The actual transmission will be done by the PHY (physical) layer 140, which includes baseband and RF processing, through the actual channel.

When a communication node is admitted into the network, it is initially granted a bandwidth according to its QoS requirement. The initial bandwidth allocated upon its admission to the network may be, for example, based on its average data rate. In a MBOA system, the granted bandwidth will be in the form of DRP slots. For variable bit rate (VBR) traffic, the actual instantaneous data rate may be very different from the average data rate. A fixed bandwidth allocation throughout will result in either poor service quality or an inefficient utilization of resources, or both. For example, if a high quality of service is required, the bandwidth allocated should be close to the maximum data rate of the source. However, in this case, most of the bandwidth will be wasted as the maximum data rate is reached only very occasionally. On the other hand, if less bandwidth is granted to each device to achieve better utilization, quality of service at times of higher data rate will have to be sacrificed. A dynamic bandwidth allocation scheme of this invention will mitigate such a dilemma.

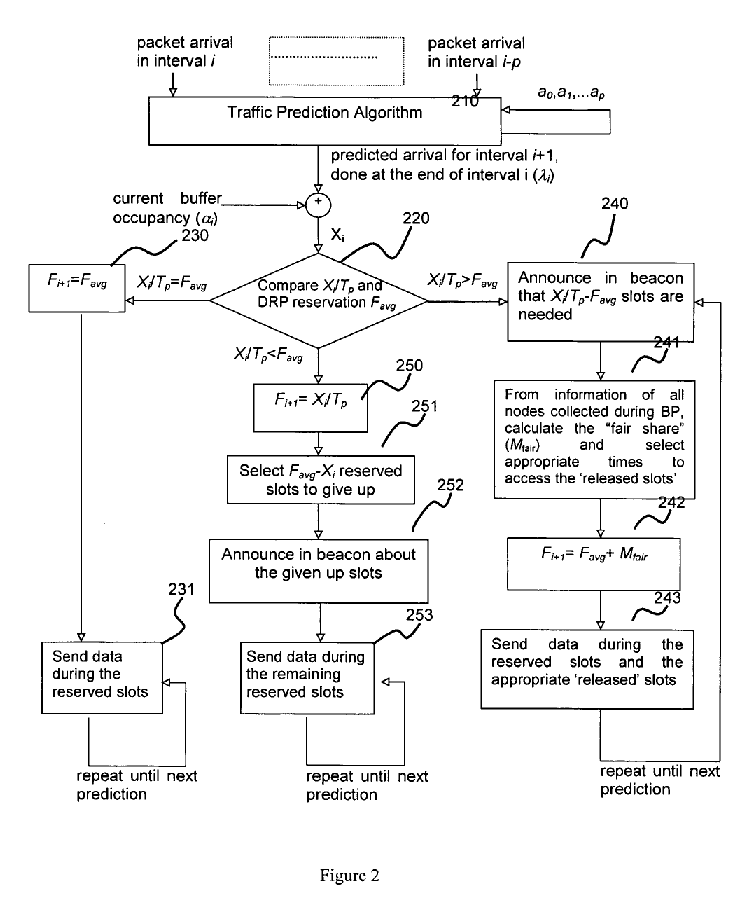

The DBA scheme comprises the following components and is illustrated more particularly with reference to FIGS. 2-4.

Prediction of Incoming Traffic

For example, at the end of each time interval k, the queue length (qₖ) at the buffer for each source will be checked. A prediction for the number of incoming packets (λₖ) for the next time slot will be made based on one of the algorithms which will be discussed later. The anticipated amount of traffic that needs to be handled in time interval k+1, predicted at the end of time interval k, is Xₖ=qₖ+λₖ

Calculation of Bandwidth Requirements

The predicted traffic is then used to determine the appropriate allocation a source should get in the next time slot. This anticipated bandwidth Xₖ, will be compared to the current bandwidth allocation Fₖ, to determine whether the allocation for the next interval k+1 should be more, less or unchanged.
If Xₖ-Fₖ=0, Fₖ₊₁=Fₖ
If Xₖ-Fₖ<0, Fₖ₊₁=Xₖ, and the bandwidth Fₖ-Xₖ will be contributed to the dynamic pool.

If Xₖ-Fₖ>0, this node will compete for more bandwidth through DBA. Fₖ₊₁ will be determined using one of the algorithms discussed later.

Release of Extra Bandwidth

All ‘extra’ bandwidth contributed by the low rate devices by way of time slot releasing will be considered as a pool of bandwidth available for dynamic allocation (C). This bandwidth will be allocated to nodes competing for more bandwidth, for example, by using one of the approaches to be discussed below.

Nodes which have made prediction that a smaller bandwidth will be required during the next superframe can announce in its beacon packet, for example, by using an ASIE, the number of slots that it is going to temporarily “release”. Similarly, nodes that require more bandwidth can announce in the beacon, also through an ASIE, the number of slots that it would like to request. Thus, each node would have sufficient information to perform calculation for its fair share bandwidth. However, it should be noted that this “release” of bandwidth does not involve any cancellation of DRP reservations. The release is only temporary and is valid until the next bandwidth prediction process. At the next superframe, each of the nodes will perform bandwidth allocation on the assumption that their specific bandwidth allocation is the same as originally allocated upon admission into the network.

Distributed Bandwidth Acquisition

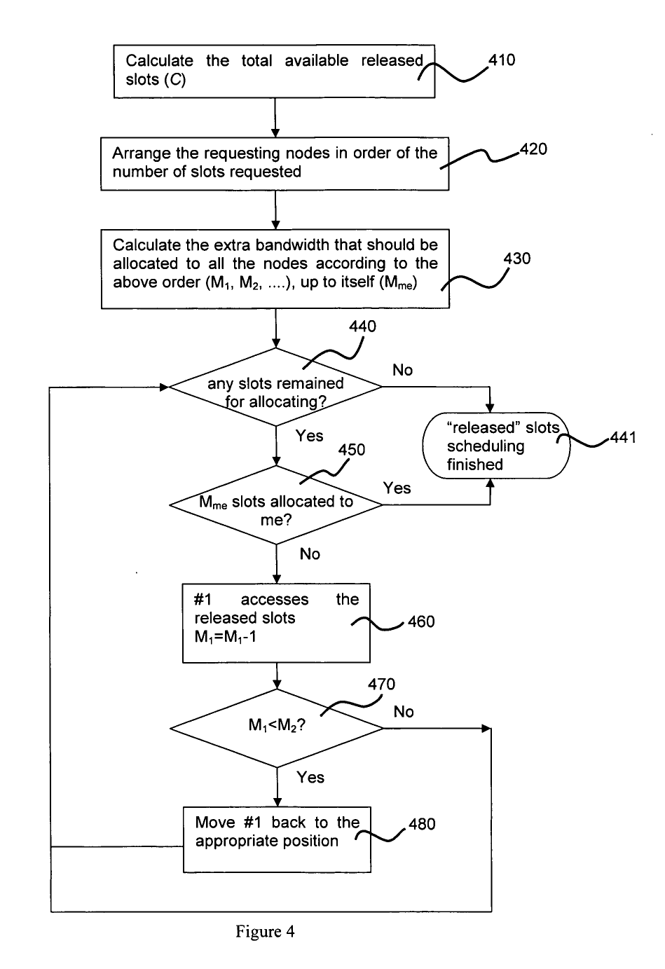

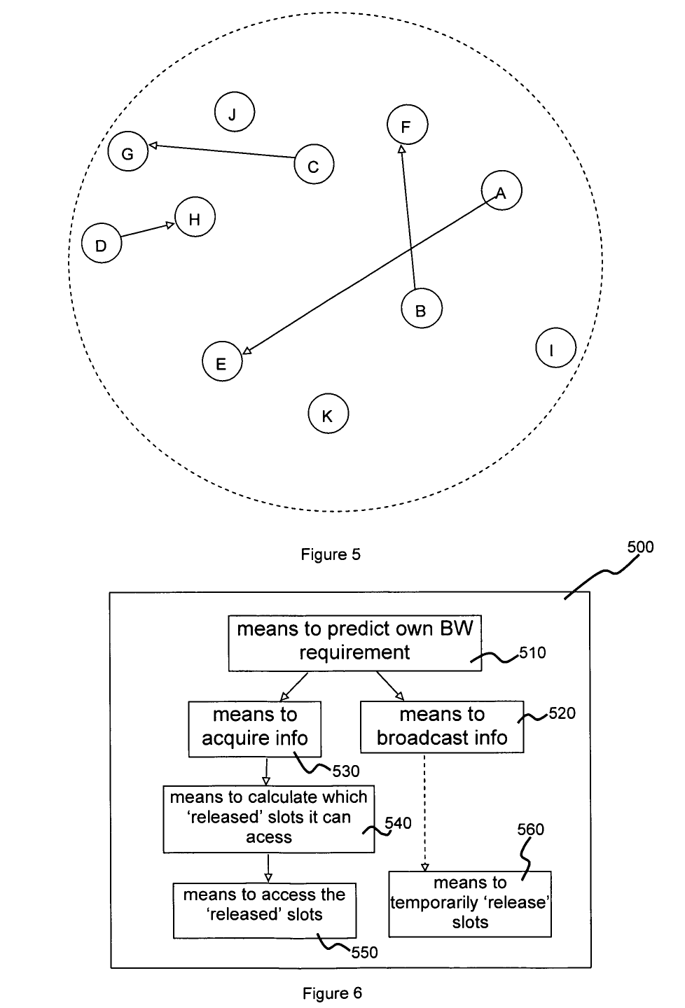

Referring also to the example of a one-hop system of FIG. 5, all nodes will be able to obtain the same information about the network. When fair share calculation is performed, the same results will be obtained. In this way, an order of priority as to which node shall have access to which “released” slot would be determined. Such available time slots are accessed through PCA. In this scheme, only one node will ‘contend’ for access. This will guarantee its success. Flowcharts of exemplary approach to access the “released” slots are shown in FIGS. 4 and 5.

Using this DBA scheme, each node can be initially granted a bandwidth equal to, say, its average data rate. Statistically speaking, at any instant, it is most likely that some sources will have a higher than average data rate while others are having a lower than average rate. The DBA scheme will temporarily reallocate any ‘extra’ bandwidth that is unused by a source having low temporal data rate to another source having a high temporal data rate. A general flow of the scheme is shown in FIG. 2. Referring to FIG. 2, firstly, a traffic prediction algorithm 210 is performed and the prediction is based on previous traffic. Together with the current buffer occupancy, the total number of slots that is required to handle the anticipated traffic before the next prediction period is calculated (Xᵢ) (220). In step 220, Xᵢ is divided by the time before the next prediction (Tₚ) (in terms of frames). The number of DRP slots that are required during this period is calculated. Comparing this number to the DRP slots that it has reserved (F_{avg}), if they are the same, the allocation for the following period (Fᵢ₊₁) will remain as F_{avg.}, as shown in step 230, and it can send data in all its reserved slots, as shown in step 231; if the former is higher, it will announce in the beacon the number of extra slots that it requires, as shown in step 240, and collect the same kind of information from other nodes to come up with a “fair share” number of extra slots that it should access in the following period, as shown in step 241 and step 242, and send data during the reserved slots and the appropriate “extra” slots that it has acquired, as shown in step 243; if the former is less, it will decide that in the next period, it will only utilize the calculated number of slots, as shown in step 250, and select the “extra slots” to give up, as shown in step 251, and announce in its beacon about such information, as shown in step 252, and data should only be sent during the remaining reserved slots, as shown in step 253.

To achieve efficient dynamic bandwidth allocation, it is desirable that there is an accurate description of the bandwidth requirement. In order to avoid loss of packets, the amount of traffic in the buffer must not exceed a certain size and packets should not stay in the buffer for an extended period of time. Thus, in predicting the required bandwidth, both the incoming traffic and the amount of traffic in the buffer should be taken into account. This will give a more complete picture of the overall amount of traffic that needs to be handled. Although the actual amount of incoming traffic is unknown, the amount of traffic in the buffer can be more easily ascertained. In this regard, the current buffered data is also useful for traffic prediction. An accurate prediction is important because if too much bandwidth is requested, resources will be wasted. On the other hand, if too little bandwidth is requested, some packets may be lost. Thus, a good prediction method will facilitate an efficient DBA.

As a convenient example, for MPEG videos, it has been found that the traffic pattern follows an autoregressive (AR) model quite closely. With this traffic model, satisfactory predictions can be achieved, as will be explained later, although it should be noted that not all kinds of traffic follow the AR model. For such non-AR traffics, other prediction methods may be needed. For example, internet traffic has been found to be non-linear and self-similar and such characteristics are considered when deposing prediction schemes. For example, schemes based on neural networks or fuzzy logic have been proposed. Examples include Boosting Feed Forward Neural Network and Adaptive Fuzzy Clustering techniques. In the absence of suitable prediction methods, for example, if they are overly complicated or not sufficiently accurate, the DBA scheme can still achieve certain improvements by using information on the queue length in the buffer. In the exemplary implementation, the predicted traffic and the buffer queue length takes equal weighting and are dealt with in the same manner. Of course, it is possible to consider the factors separately or use unequal weighting when making a bandwidth request. This will mainly be reflected in the specific algorithm for deciding the access schedule.

After the amount of bandwidth that a node will require in order to handle its traffic in the next ‘round’ has been determined, it will be necessary to compare the bandwidth requirements to the number of allocated slots. If the number of time slots is the same as that allocated on admission to the network, no bandwidth adjustment is required. If more or less time slots are required, such information will be included in its beacon packet in the case of MBOA, this information can be added in the ASIE. Since the beacon packet is a broadcast message that will be heard by all nodes in the network and contains critical information about each node for successfully setting up the network and communication links between nodes, the bandwidth information will be made known to all nodes. The bandwidth information will include, for example, the number of extra slots requested, the number of slots that can be released, and/or the destination address and the stream ID. In some cases, more information may be required, as will be explained later.

After the beacon period in the superframe, each node will have collected information of all the other nodes. At this point, each node would have been aware whether it is the destination of any of such bandwidth request or ‘release’. In cases where sleep mode is implemented, a node which is the source of bandwidth release can go into sleep mode during the appropriate time slots. If it is the destination of bandwidth request, the access schedule will have to be computed so that it will not be in sleep mode during the extra acquired slots or it can remain on at all times.

For nodes which have not sent out any request/release information, they can just continue to use the assigned time slots to send information. For nodes which have sent out bandwidth release information, they have to refrain from sending data during the time slots that it has released. This is even if the prediction was bad and it turns out to have more data to send than expected to avoid conflict. For nodes which have sent out bandwidth requests, they should perform calculations, as detailed later, to derive an access schedule for the released slots. They are entitled to send data during both their assigned slots and those ‘released’ slots that have been acquired by them.

In this DBA scheme, all information required to perform bandwidth allocation is exchanged during the beacon period. Bandwidth information is only valid for one superframe, but it is not necessary that the bandwidth information is for the current or immediately subsequent superframe. In order to allow enough time for computation, the information exchanged for bandwidth prediction and slot request during the beacon period can be used for actual dynamic bandwidth allocation in, say, the next superframe or the one after the next. Although by then the information may not be the most updated and best performance may not be achieved, it may still be feasible. However, it should be noted that the information used in the allocation process must be obtained from beacons during the same superframe, and the delay each node takes in processing the bandwidth information will be equal.

Furthermore, the prediction process can occupy quite substantial computational power, this computation burden may be too large on a communication node if bandwidth predictions are performed too frequently. To alleviate this, prediction is performed for every GOP (12 video frames) at the most frequent. In order to maintain a balance between bandwidth usage performance improvement and computational power, the interval between predictions can be increased or decreased without loss of generality. Nevertheless, bandwidth release/request information should be sent in the beacon packet in every superframe, regardless of whether a prediction has been newly performed. In between predictions, the bandwidth request may remain the same or it may change according to queue length status or the amount of traffic that has arrived.

Additional details on the individual parts of the scheme with video applications as an example will be described below.

Video Traffic Prediction Model—AR Model

Video traffic is characterised as a mathematical model in order to do traffic prediction. There are many video encoding systems and the traffic model is highly dependent on the encoding method.

In the MPEG video systems (MPEG 1, 2 or 4), frames are generated at a rate of about 25 to 30 per second. In general, the frame size would be small when the scene is more sedate and the frame size would be large if a lot of action or movements are involved. Also, the frame size would usually remain quite constant during a scene, and an abrupt increase/decrease would be present when there is a scene change.

The frames can be classified into 3 types: Intraframe (I), Predictive frames (P), and Bidirectionally Predictive frames (B). I frames are encoded independent of other frames, resulting in a low compression ratio, but providing a point of access. P frames are encoded using motion-compensated prediction of the previous I or P frame, thus a higher compression ratio can be achieved. B frames are usually the smallest as they are encoded using bidirectional prediction based on the nearest pair of past and future I—P, P—P, or P—I frames. The I, P and B frames are generated in a fixed cyclic sequence of length N, starting with an I frame, and ending before the next I frame; and for every M^{th} frames, there will be a P frame. Typically, N=12 and M=3, resulting in a sequence of IBBPBBPBBPBB. This is called a group-of-picture (GOP). The GOP size is the sum of all the 12 frames in that GOP.

The significance of this frame classification from a statistical point of view is that, the frame size of the sequence of I frames can be modelled with a linear autoregressive (AR) model. The same applies to the sequence of P frames, B frames, and GOP. However, it should be noted that the sequence of alternating I, P and B frames do not follow the AR model. This is important information since it suggests the possibility of prediction.

The basis for prediction is the linear autoregressive (AR) model. It means the sequence has a tendency to go back to a previous state. In simple terms, it states that the current value can be estimated from the weighted sum of previous values:
x(n)=a₁x(n−1)+a₂x(n−2)+ . . . +aₚx(n−p)+be(n)

i.e., the next value is a linear combination of the previous values.

For this to be true, the terms in the sequence need to show some correlation. The stronger the correlation, the better the fit of the model. For example, an independent sequence of random numbers will not follow an AR model. The appropriateness of this model for certain data is usually shown by experimental results. MPEG video traffic has been demonstrated to fit the model quite well. The correctness of the model depends highly on determining the values of the aᵢ's.

The coefficients aᵢ's can be found as follows.
Method I: By Solving the equation Rₓₓa=−r

$$where$$

$${R}_{xx} = ( \begin{matrix}{R}_{xx} [ 0 ] & {R}_{xx} [ - 1 ] & ⋯ & {R}_{xx} [ - p + 1 ] \\ {R}_{xx} [ 1 ] & {R}_{xx} [ 0 ] & ⋯ & {R}_{xx} [ - p + 2 ] \\ ⋮ & ⋮ & ⋰ & ⋮ \\ {R}_{xx} [ p - 1 ] & {R}_{xx} [ p - 2 ] & ⋯ & {R}_{xx} [ 0 ]\end{matrix} ) , \\ a = {[ {a}_{1} , {a}_{2} , … , {a}_{p} ]}^{T} , \\ r = {[ {R}_{xx} [ 1 ] , {R}_{xx} [ 2 ] , … , {R}_{xx} [ p ] ]}^{T}$$

Rₓₓ[n]=E{(X(t)−E[X(t)])(X(t+n)−E[X(t)])} represents the autocovariance of a wide-sense stationary (WSS) process X at a time interval of n.

To solve this equation, the mean and autocovariance of X, which is the number of received packets, will be required. A running count can be performed and these statistics can be updated with every new data point.

Method II: Adaptive filter

In this method, the coefficients in a are updated with each new data point.

The update formula can take the form:
i) a(n+1)=a(n)+μe(n)x(n)
ii) a(n+1)=a(n)+[μe(n)x(n)/||x(n)||²

where e(n)=x⁻(n)−x(n) is the error of the previous prediction

μis a constant called the step size, which has to be chosen carefully to ensure convergence.

The above are just examples of methods that can be used to find the coefficients for the AR model. There are other methods and the DBA scheme is not in any way limited to the use of any one particular method.

Although video traffic has been used in this exemplary implementation, the DBA scheme is by no means restricted to video traffic applications. Other traffics, for example, internet, voice or audio can all be handled by this DBA scheme. Naturally, a suitable prediction method will be required in the prediction process. As a convenient example, internet traffic can be predicted using neural network methods and/or fuzzy logic techniques.

Bandwidth Allocation Schemes

Turning next to the re-allocation of bandwidth released by some nodes and assuming that there is a certain amount of bandwidth (C) available for dynamic allocation. The available bandwidth can be allocated to different nodes seeking more bandwidth according to prescribed allocation schemes. Examples of some appropriate bandwidth allocation schemes are described below as a convenient reference. The specific bandwidth allocation algorithm that should be incorporated in the DBA scheme would be according to requirements of a specific application and is by no means restricted to any of the following.

1. Proportional Linear Algorithm

Assuming that the anticipated bandwidth required by source i is Xᵢ, and there are N users requiring more bandwidth. Let Fᵢ denote bandwidth allocation. The most intuitive approach is to allocate the bandwidth according to:
Fᵢ=(Xᵢ/Σ^{N}ⱼ₌₁Xⱼ)*C

This is probably the most straightforward and most efficient in terms of resource utilization.

2. Proportional Polynomial Algorithm

Since the linear algorithm cannot prevent large queues from getting larger, it may introduce unfairness and problems. To mitigate this problem, more bandwidth would be allocated to streams with larger queues, by a nonlinear allocation procedure. The non-linear specific allocation scheme is as follows:
Fᵢ=(Xⁿᵢ/Σ^{N}ⱼ₌₁Xⁿⱼ)*C
where n is the degree of the polynomial.

With increasing n, the asymptotic behavior of the queue lengths get closer, but the disparity in queue length growth still exists as long as the data rates are different.

3. Minmax Algorithm

To achieve a fair long-term buffer growth, a fair distribution is required to keep the maximum queue length as small as possible. This is formulated as a constrained optimization problem:

$$\begin{matrix}Minimize & max \{ {X}_{i} - {F}_{i} \} \\ Subject to & \{ \begin{matrix}{Σ}_{i = 1}^{n} {F}_{i} = C \\ {F}_{i} \leq {X}_{i} \\ {F}_{i} \geq 0\end{matrix}\end{matrix}$$

To solve this problem:

1) requirements are arranged in a descending order:

2) X₁≦X₂≦ . . . ≦X_{N,} where N is . . .

3) the portion g₁ of C that needs to be allocated to X₁ so that the remaining requirement X₁−g₁ is equal to X₂, is calculated,

4) the portion g₂ of the remaining capacity C-g₁ that needs to be allocated to both X₁-g₁ and X₂ so that the remaining requirements X₁-g₁-g₂ and X₂−g₂ are equal to X₃, is calculated.

5) steps 3) and 4) are repeated until the available capacity is exhausted.

This method can be used to prevent the growing discrepancy of the queue lengths.

4. Proportional Exponential Algorithm
Fᵢ=[exp(Xⁿᵢ) Σ^{N}ⱼ₌₁exp(Xⁿⱼ)]*C

This algorithm offers the same asymptotic behavior as the Minmax algorithm, while keeping the run time at O(N).

5. β-dependent Allocation

β represents the queue length growth rate. The allocation can be made in proportion to the growth rate.
Fᵢ=(βᵢ/Σ^{N}ⱼ₌₁βⱼ)*C
6. Other Possible Algorithms

Allocation can be made in proportion to the rate of change of bandwidth requirement.
Fᵢ(ΔXᵢ/Σ^{N}ⱼ₌₁ΔXⱼ)*C

Methods 2, 3 and 4 above are intended to achieve fairness in terms of long term queue length, when the source rate is more or less static. For VBR traffic, since the source rate will vary from time to time, the long term fairness in this sense may not be an issue.

Choosing Which Slots to Release

During the bandwidth prediction phase, each node will have to determine how much bandwidth it will require and will seek to obtain extra bandwidth if the required bandwidth exceeds the allocated bandwidth obtained upon admission into the network. If a node requires less bandwidth and can temporarily “release” some slots, it will be necessary to decide which slot to be released. In general, there are two main approaches: 1) each node can choose which slots it wants to release, independently; 2) a rigid, unified criteria will be used by all nodes to make the choice. In the first case, flexibility is higher. For example, nodes can choose to give up slots according to channel conditions. There can be cases where channel condition could be particularly poor during certain time slots, due to, e.g., another transmission in a neighbouring cluster. For example, if a node has decided it wants to “release” a few slots, it would release slots having poor channel condition. Another example is that, if the traffic of a particular node has a large packet size, it may like to send during consecutive slots and choose not to release those. Each node can decide which criterion is more important to it, based on its traffic, the channel, or some other factors. To implement this, every node will need to include a list of its “released” slot number. This will result in more information having to be exchanged and may increase the workload of the system. In the second case, each node only needs to announce the number of slots it is “releasing” and every other node will know which slots they are (assuming that the protocol already requires every node to broadcast its reservation schedule). For example, in order to allow for more time for processing, nodes should “release” the last slots in its reservation schedule.

Accessing the Released Slots

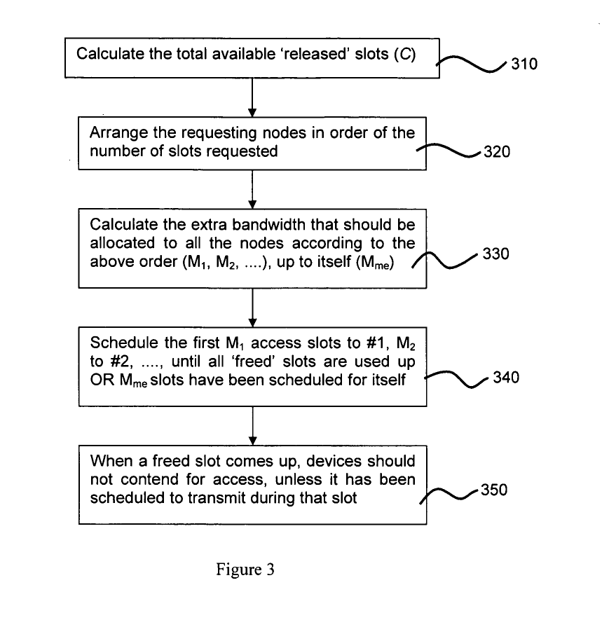

Two exemplary methods for assigning the “released” slots are shown in FIG. 3 and FIG. 4. Both examples start with the summing up of the total number of available ‘released’ slots from the broadcasted information (310, 410). The nodes will then be queued up according to the number of extra slots that they are requesting (320, 420). The implementation of this ordered queue may be way of employ any data structure, preferably one where elements can be inserted in a correct order. The number of slots that each of these nodes is requesting also needs to be stored. According to this ordering, the number of extra slots that each of the nodes should be entitled to is calculated (330, 430). The calculation method may be any of the suggested criteria stated in the previous sections, but this is by no means limited only to those criteria. In order to save processing power, a particular node only needs to do the calculation up to itself. That is because a node only needs to know about the allocation before itself and its own ‘fair share’ of extra slots to effectively carry out the following steps. Knowledge of what happens after that point is of no particular value. In the first method, the entire amount of slots requested by a node will be assigned together, as shown in step 340 and 350. The assignment method is to assign the first M₁ freed slots (the fair share of the most prioritized node, say ‘#1’) to #1; then assign the next M₂ freed slots to the second most prioritized node #2. The process will continue until it has done the scheduling for itself, or until all freed slots have been allocated, whichever happens earlier. This is computationally simpler but is likely to result in unfairness. In the second method, one slot is assigned at a time, and the priority order will change along the way as shown in the steps 440, 441, 450, 460, 470 and 480. When there are still ‘released’ slots remaining, a particular node will first check that it has not been allocated the total number of slots that it is entitled to (If it has been allocated enough slots that it is entitled to, the scheduling process is finished), as shown in steps 450, 441. According to the previously set up queue, the node with the highest priority (say “#1” in step 460) will access this particular ‘released’ slot. If the remaining number of slots #1 is entitled to after this allocation is still more than that of the next node in line, it will remain as #1. Otherwise, the next node will become #1 and the original #1 will be moved back along the queue accordingly. This method will achieve better fairness but the complexity and computation time will be higher. Each device which participates in DBA should perform the same procedure individually.

In general, nodes requesting more slots should have higher priority in trying to access the “released” slots. This is because the higher demand on extra bandwidth would suggest that they are in greater need of bandwidth. If two nodes are requesting the same number of slots, a mechanism will be used to determine which node gets priority. Exemplary criteria include the device id or the order of beaconing, since these numbers are unique, it will result in an absolute ordering. More sophisticated implementation may choose to consider past history of the nodes, e.g. a node which was assigned less “released” slots in the previous round should have a higher priority. In another approach, the queue and the predicted incoming traffic will be locked separately. A device with a longer queue will have higher priority. Incorporating these conditions will likely result in better performance or fairness although it may come at the expense of a higher complexity and more information may need to be exchanged during the beacon periods. In any event, the DBA scheme does not impose any restriction on what criteria should be used in deciding the priority order. The only requirement is that the method must generate a unique ordering in the end.

In this example, the DBA scheme has an advantage that each node is not required to calculate the entire “released” slots access schedule. It just needs to perform calculation up to the point where it knows when itself should access the slots. This will reduce computational time.

### EXAMPLE TO ILLUSTRATE THE EXEMPLARY OF DBA

FIG. 5 shows an example 1-hop network comprising nodes A, B, C, D, E, F, G, H, I, J, K (all nodes can hear one another). FIG. 6 is a block diagram showing an exemplary node and comprising the various means, including means to predict own BW requirement (e.g. an AR algorithm), means to acquire information (e.g. through received beacons), means to calculate which ‘released’ slots it can access (e.g. an ordered list and a calculation method), means to access the ‘released’ slots (e.g. a prioritized contention access mechanism) and means to broadcast information (e.g. beaconing) and means to temporarily ‘release’ slots (e.g. internal scheduler control). The functions and interrelationship between the blocks have been explained in details in the previous sections. Assume nodes A, B, C and D are the only source nodes that have incorporated the DBA algorithm. The arrows show the direction of data flow, i.e., node A is sending data to node E, B to F, C to G and D to H. The means that are required to enable DBA are also listed. All of A, B, C and D will possess such means. There are other nodes in the network which will not participate in the DBA process and network bandwidth is fully utilized. Each of these 4 nodes is sending a unique video of the same average bit rate but different instantaneous bit rate. Each has reserved 6 DRP slots to begin with, thus the DBA process will only work with these 24 slots.

At the end of superframe (k−1), the prediction results are as follows:

| | | | | Extra slots |
|---|---|---|---|---|
| | Prediction | Buffered | Reserved slots (slot #) | required |
| A | 8 | 4 | 6 (33, 49, 65, 81, 97, 113) | +6 |
| B | 7 | 1 | 6 (34, 50, 66, 82, 98, 114) | +2 |
| C | 1 | 0 | 6 (35, 51, 67, 83, 99, 115) | −5 |
| D | 3 | 1 | 6 (36, 52, 68, 84, 100, 116) | −2 |

At the beginning of superframe (k):

Each of A, B, C and D will send an ASIE in its beacon, requesting the number of extra slots as indicated in the above table. After they have received all beacons, they will process them for DBA:
A: it is requesting the most number of extra slots, so it has the highest priority. When all the requested slots are summed, the result is 8. The total number of released slots is 7 and all the slots that are freed are recorded: 51, 67, 83, 99, 115 (the last 5 DRP slots are from node C) and 100 and 116 (the last 2 DRP slots from node D).

List stored A:

Priority List (up to itself): A

Freed Slots: 51, 67, 83, 99, 100, 115, 116

It will then perform the following calculations:
No. of freed slots A should use=7*(6/8)=5.25 (rounded to 5)
A should access the first 5 freed slots: 51, 67, 83, 99, 100

Calculations for A finished.
B: It is requesting the second most number of extra slots, so it has the second priority. Again, it collects all the information as A does.

List it has stored:

Priority List (up to it): A→B

Freed Slots: 51, 67, 83, 99, 100, 115, 116

It will then perform the following calculations:

For A: No. of freed slots A should use=7*(6/8)=5.25 (rounded to 5)

For B: No. of freed slots B should use=7*(2/8)=1.75 (rounded to 2)

B should access the 2 freed slots after the first 5: 115, 116

Calculations for B finished.
C: It is not requesting for extra slots, no need to perform any calculations.
D: Same as C.

It should be noted that the released slot assignment is only valid for one superframe. For VBR traffic, at the end of superframe (n-1), the slot requirement table may become like this:

| | | | | Extra slots |
|---|---|---|---|---|
| | Prediction | Buffered | Reserved slots (slot #) | required |
| A | 1 | 0 | 6 (33, 49, 65, 81, 97, 113) | −5 |
| B | 5 | 2 | 6 (34, 50, 66, 82, 98, 114) | +1 |
| C | 8 | 2 | 6 (35, 51, 67, 83, 99, 115) | +4 |
| D | 7 | 2 | 6 (36, 52, 68, 84, 100, 116) | +3 |

After receiving the beacons in superframe (n):
A: It is not requesting for extra slots, no need to perform any calculations.
B: Information it has stored:

Total number of requested slots=8

Total number of released slots=5

Priority List (up to myself: C→D→B

Freed Slots: 49, 65, 81, 97, 113

Calculations:
For C: No. of freed slots C should use=5*(4/8)=2.5 (rounded to 3)
For D: No. of freed slots D should use=5*(3/8)=1.875 (rounded to 2)
For B: No. of freed slots B should use=5*(1/8)=0.625 (rounded to 1)
B should access 1 freed slot after the first 5. However, there are only 5 freed slots, so B will not get access to any.

Calculations for B finished.
C: Information it has stored:

Total number of requested slots=8

Total number of freed slots=5

Priority List (up to myself): C

Freed Slots: 49, 65, 81, 97, 113

Calculations:
For C: No. of freed slots C should use=5*(4/8)=2.5 (rounded to 3)
C should access the first 3 freed slots: 49, 65, 81

Calculations for C finished.
D: Information it has stored:

Total number of requested slots=8

Total number of freed slots=5

Priority List (up to myself): C→D

Freed Slots: 49, 65, 81, 97, 113

Calculations:
For C: No. of freed slots C should use=5*(4/8)=2.5 (rounded to 3)
For D: No. of freed slots D should use=5*(3/8)=1.875 (rounded to 2)
D should access 2 freed slots after the first 3: 97, 113

Calculations for D finished.

The above is a very simple example that can illustrate the basic functioning of the allocation process. As mentioned before, the method to assign priority or to calculate the number of freed slot each node should access are not restricted.

To implement the above in a DBA, an exemplary network node is shown in FIG. 6. The communication network comprises a plurality of communication nodes, wherein each one of said plurality of communication nodes can transmit data at a variable bandwidth, each communication node comprises:
Means for predicting its own bandwidth requirements 510,
Means for communicating its predicted own bandwidth requirements to the network (520),
Means for acquiring bandwidth requirement information of other communication nodes on the network (530), and
Means for determining its own bandwidth allocation according to a common bandwidth allocation scheme (540), said common bandwidth allocation scheme is available to said plurality of communication nodes.

In addition, the network also comprises means to access the released slots (550) and means to temporarily release slots (560).

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to a MBOA system, it should be appreciated that the invention can apply, whether with or without modification, to other distributed communication network without loss of generality.

1. A communication network comprising a plurality of communication nodes, wherein each one of said plurality of communication nodes can transmit data at a variable bandwidth, each communication node comprises:
Means for predicting its own bandwidth requirements,
Means for communicating its predicted own bandwidth requirements to the network,
Means for acquiring bandwidth requirement information of other communication nodes on the network, and
Means for determining its own bandwidth allocation according to a common bandwidth allocation scheme, said common bandwidth allocation scheme is available to said plurality of communication nodes.

2. A communication network according to claim 1, wherein bandwidth requirements of a communication node are broadcast to said plurality of communication nodes.

3. A communication network according to claim 1, wherein network communication uses a time division multiple access protocol, the protocol divides a communication time period in the network into a plurality of time slots, a prescribed number of time slots is reserved for exchange of bandwidth information between the communication nodes and a prescribed number of time slots is reserved for data transmission by the communication nodes.

4. A communication network according to claim 3, wherein each time channel is a superframe comprising 256 time slots, each time slot is 256 μs long, prescribed time slots in a superframe are reserved for a specific communication node for exchange of bandwidth information and transmission of data upon admission into the network.

5. A communication network according to claim 1, wherein bandwidth requirements of said plurality of communication nodes are broadcast during beacon period.

6. A communication network according to claim 1, wherein said common bandwidth allocation scheme comprises a fair share allocation scheme whereby transmission bandwidth allocated to a specific communication node is dependent on its predicted bandwidth requirements relative to the overall bandwidth requirements of said plurality of communication nodes.

7. A communication network according to claim 1, wherein each one of said plurality of communication nodes comprises means for contending for additional bandwidth when the total bandwidth required by a said communication node exceeds the bandwidth reserved by said communication node.

8. A communication network according to claim 7, wherein said additional bandwidth is contended by a communication node through a set of bandwidth reservation contention protocol common to said plurality of communication nodes.

9. A communication network according to claim 7, wherein only one communication node is allowed to contend for additional bandwidth during a said time slot during which said plurality of communication nodes can communicate with each other.

10. A communication node according to claim 1, wherein the prescribed set of bandwidth allocating rules comprises rules of prioritising bandwidth allocation to a communication node.

11. A communication network according to claim 1, wherein each communication means comprises means for causing data communication in said distributed network at a variable bandwidth.

12. A communication network according to claim 11, wherein said means for causing data communication in said distributed network can increase as well as decrease the data communication bandwidth of said communication node, the increase and decrease in data communication bandwidth is broadcast in said communication network during the beacon period.

13. A communication network according to claim 11, wherein said communication node further comprises means to release data communication bandwidth for use by other communication nodes if the predicted bandwidth requirements of said communication node is lower than existing bandwidth requirements.

14. A communication network according to claim 11, wherein said communication node further comprises means to compete for additional data communication bandwidth for its own use if the predicted bandwidth requirement of said communication node is higher than current bandwidth.

15. A communication network according to claim 1, wherein said means for predicting bandwidth requirements of a communication node comprises means to predict immediate subsequent bandwidth of incoming traffic from traffic pattern of the most recent incoming traffic.

16. A communication network according to claim 15, wherein said means for predicting bandwidth requirements of said communication node further comprises means to determine data traffic buffered in said communication node so that the predicted bandwidth requirements is a function of both the traffic pattern of current incoming traffic and the buffered traffic.

17. A communication network according to claim 1, wherein said common bandwidth allocation scheme comprising a priority scheme, the priority scheme grants priority to a node requiring more bandwidth to have a priority when acquiring additional bandwidth.

18. A communication network according to claim 1, wherein the traffic of said communication node is MPEG videos and the prediction of bandwidth requirements is based on a linear autoregressive model.

19. A communication network according to claim 1, wherein data communication bandwidth is available as a plurality of time slots and the allocation of bandwidth in situation of competition is under a fair share principle.

20. A communication network according to claim 1, wherein data communication bandwidth available for allocation is distributed to communication nodes competing for extra communication bandwidth using one of the following algorithm-proportional linear algorithm, proportional polynomial algorithm, minimax algorithm, proportional exponential algorithm, β-dependent allocation algorithm, wherein β is the queue length growth rate, and like algorithms.

21. A communication network according to claim 1, wherein said communication network has a MBOA or WiMedia architecture.

22. A method of bandwidth management for a distributed communication network, the distributed communication network comprises a plurality of communication nodes, the method comprises the following steps:
Predicting bandwidth requirements of the plurality of communication nodes,
Communicating bandwidth requirements of said plurality of communication nodes onto said communication network,
Allocating communication bandwidth to said plurality of communication nodes according to a common allocation scheme shared by said plurality of communication nodes.

23. A method of bandwidth management according to claim 22, wherein each said communication node comprises means to adjust transmission bandwidth according to the instantaneous allocated transmission bandwidth.
